(19) United States
(12) Patent Application Publication
(10) Pub. No.: US 2011/0065845 A1
(43) Pub. Date: Mar. 17, 2011

(54) HALOGEN-FREE FIRE RETARDANT COMPOSITIONS

(75) Inventors: Elisabeth Serafeim Papazoglou, Yardley, PA (US); Don Gary Barber, West Chester, PA (US)

(73) Assignee: Polymer Products Company, Inc., Stockertown, PA (US)

(21) Appl. No.: 12/877,491

(22) Filed: Sep. 8, 2010

Related U.S. Application Data
(60) Provisional application No. 61/240,419, filed on Sep. 8, 2009.

(51) Int. Cl. C08K 5/3492; C08K 3/34; C08K 5/521

(52) U.S. Cl. 524/101; 524/450; 524/145; 524/443

(57) ABSTRACT

A chlorine- and bromine-free fire retardant composition based on organic polymer and zeolite is disclosed.

### CROSS-REFERENCE TO RELATED APPLICATION

This application claims priority from U.S. Provisional Application No. 61/240,419, filed Sep. 8, 2009, and incorporated herein by reference in its entirety for all purposes.

### FIELD OF THE INVENTION

This invention relates to flame-retardant compositions based on organic polymers. In particular, this invention relates to halogen-free flame-retardant compositions that comprise zeolite as a flame retardant.

### BACKGROUND OF THE INVENTION

Many common articles, such as household appliances, office equipment, electrical and electronic devices, building materials, and automotive parts comprise shaped or molded organic polymers. A serious problem with these materials is their flammability, which can limit their use in certain applications that require high flame resistance. One way of reducing flammability is addition of one or more flame-retardant additives to the polymer.

A commonly used flame-retardant system is a combination of a halogen-containing compound, typically a bromine-containing compound, and antimony oxide. Although halogen-based flame-retardants can impart excellent flame-retardancy to the polymer, in a fire they evolve halogen-containing gases, which are generally very toxic. In addition, some bromine-containing flame-retardants (especially brominated diphenyl ethers) can form toxic compounds at elevated temperatures and have also been linked to tumor formation, making them possible carcinogens. Additionally, the presence of halogenated aromatic compounds in electronic devices interferes with recycling of these materials. Consequently, a global trend exists for the replacement of halogen-containing flame-retardant systems with halogen-free systems.

Phosphorus-containing flame retardants, such as organic phosphates, for example triphenyl phosphate, cresyl diphenyl phosphate, bisphenol A diphosphate or tricresyl phosphate, have been used in place of halogen-containing compounds. However, many organic phosphates can adversely affect the physical properties of the polymer because they can act as plasticizers and also can absorb moisture. Moisture absorption can cause stress cracking of the polymer as well as decomposition of the phosphate ester. In addition, phosphorus compounds can create environmental problems, such as the eutrophication of lakes and rivers. Consequently, a need exists for halogen-free flame-retardant polymer compositions containing reduced amount of phosphorus compounds.

### BRIEF SUMMARY OF THE INVENTION

The invention is a halogen-free flame-retardant polymer compositions with a reduced amount of phosphorus compound. The composition comprises:

(a) 100 parts by weight of organic polymer;

(b) optionally, a non-halogenated flame retardant such as a phosphorus-containing flame retardant or a melamine flame retardant; and

(c) at least 3 parts by weight of zeolite;

in which the composition is essentially free of flame-retardant compounds that contain chlorine or bromine and essentially free of polymers that contain chlorine or bromine. The amount of non-halogenated flame retardant may be varied as desired, e.g., from 0 to 20 parts by weight (alternatively, from 0 to 12 parts by weight) per 100 parts by weight organic polymer or even greater. In one embodiment, a phosphorus-containing flame retardant is present and the phosphorus-containing flame retardant:zeolite weight ratio is not more than 4 (alternatively, not more than 3.7, not more than 3, not more than 2.3, not more than 1.8, not more than 1). However, in other embodiments the phosphorus-containing flame retardant:zeolite weight ratio is greater than 4.

Also provided by the invention is a method of improving the flame retardancy of an organic polymer. This method comprises combining 100 parts by weight of said organic polymer with at least 3 parts by weight zeolite but essentially no flame-retardant compound that contains chlorine or bromine and essentially no polymer that contains chlorine or bromine. In certain aspects of the invention, the amount of non-halogenated flame retardant (if any) combined with the organic polymer can be limited to not more than 20, 16 or 12 parts by weight per 100 parts by weight organic polymer. In other aspects, the phosphorus-containing flame retardant:zeolite weight ratio can be controlled so that it does not exceed 4.

The present invention is capable of providing compositions having a Limiting Oxygen Index of 29 or greater and a UL-94 rating (measured using a sample thickness of 1/16″) of V-0.

In one aspect of the invention, the zeolite is an ion-exchanged zeolite, in particular, a zinc-exchanged zeolite.

In other aspects of the invention, the total amount of (non-halogenated flame retardant+zeolite) is at least 9, 10, 11 or 12 phr.

In one embodiment of the invention, a composition is provided which comprises about 80 to about 90 weight % of a blend of polycarbonate and acrylonitrile butadiene styrene resin, wherein the blend has a polycarbonate: acrylonitrile butadiene styrene resin weight ratio of from about 3:1 to about 5:1, about 2 to about 6 weight % of at least one zeolite selected from the group consisting of natural zeolites and zinc-exchanged zeolites, about 8 to about 12 weight % triphenyl phosphate, and about 0.1 to about 0.5 weight % of fluoropolymer anti-drip agent, wherein the composition is essentially free of flame-retardant compounds that contain chlorine or bromine and essentially free of, polymers that contain chlorine or bromine.

In another embodiment of the invention, a composition is provided which comprises about 80 to about 90 weight % of a blend of polycarbonate and acrylonitrile butadiene styrene resin, wherein the blend has a polycarbonate: acrylonitrile butadiene styrene resin weight ratio of from about 7:1 to about 9:1, about 3 to about 6 weight % of at least one zeolite selected from the group consisting of natural zeolites and zinc-exchanged zeolites, about 10 to about 13 weight % bisphenol A bis(diphenyl)phosphate, and about 0.1 to about 0.5 weight % of fluoropolymer anti-drip agent, wherein the composition is essentially free of flame-retardant compounds that contain chlorine or bromine and essentially free of polymers that contain chlorine or bromine.

In another embodiment of the invention, a composition is provided which comprises about 75 to about 75 weight % of polypropylene, about 5 to about 15 weight % of polyamide, about 2 to about 8 weight % of compatibilizer (in particular, a maleated polypropylene compatibilizer), about 5 to about 15 weight % of melamine flame retardant, about 3 to about 10 weight % zeolite, and 0 to about 0.5 weight % of fluoropolymer anti-drip agent, wherein the composition is essentially free of flame-retardant compounds that contain chlorine or bromine and essentially free of polymers that contain chlorine or bromine.

In another embodiment of the invention, a composition is provided which comprises about 30 to about 45 weight % of polypropylene, about 10 to about 20 weight % of polyamide, about 2 to about 8 weight % of compatibilizer (in particular, a maleated polypropylene compatibilizer), about 30 to about 45 weight % of phosphorus-containing flame retardant (in particular, an ammonium polyphosphate-containing flame retardant), and about 3 to about 10 weight % zeolite, wherein the composition is essentially free of flame-retardant compounds that contain chlorine or bromine and essentially free of polymers that contain chlorine or bromine.

### DETAILED DESCRIPTION OF THE INVENTION

Parts per hundred (phr) refers to parts by weight of additive per one hundred parts by weight of organic polymer. The term “zeolites” includes ion-exchanged zeolites. Unless the context indicates otherwise, in the specification and claims the terms zeolite, ion-exchanged zeolite, non-halogenated flame retardant, and similar terms also include mixtures of such materials.

The invention provides a halogen-free flame-retardant polymer composition. “Halogen-free” means that the composition is essentially free of flame-retardant compounds that contain chlorine and/or bromine, such as tetrabromobisphenol A, brominated cyclohydrocarbons such as hexabromocyclododecane, polybrominated diphenyl ethers, polybrominated biphenyls, chlorinated short to medium chain hydrocarbons, and bis(hexachlorocyclopentadieno)cyclo-octane. The composition is also free of polymers that contain chlorine and/or bromine, such as brominated polystyrenes, brominated polycarbonates, brominated epoxies or polyvinyl chloride. Small amounts of chlorine and/or bromine containing compounds may be present as impurities, but the total bromine and chlorine content of the composition is less than 0.5 wt. % (in certain embodiments, less than 0.4, 0.3, 0.2, or 0.1 wt. % or even 0 wt. %). However, fluorinated polymers, such as polytetrafluorethylene (PTFE), may be present in the composition as anti-drip agents.

The organic polymer may be any thermoplastic or thermoset polymeric substance, but in one embodiment the organic polymer includes at least one polycarbonate and in another embodiment includes at least one polypropylene. In another embodiment, the organic polymer is a blend of different polymers such as, for example, a blend of polycarbonate and a nitrile, diene and/or styrenic polymer such as an acrylonitrile butadiene styrene (ABS) resin or a blend of polypropylene and polyamide (e.g., nylon 6). The weight ratio of polycarbonate:ABS or polypropylene:polyamide may be about 2:1 to about 10:1, for example. For certain combinations of organic polymers, it may be helpful or preferred to also include one or more compatibilizers known in the art that are capable of improving the compatibility of the different polymers when blended. For instance, a maleated polyolefin such as a maleic anhydride-reacted polypropylene may be utilized in formulations containing a polypropylene and a polyamide.

Zeolites are natural or synthetic microporous crystalline inorganic compounds with three dimensional structures and generally contain silicon, aluminum, and oxygen in their framework and loosely held cations, water and/or other molecules in their pores. More particularly, zeolites are framework silicates consisting of interlocking tetrahedrons of SiO₄ and AlO₄. The SiO₄ and AlO₄ tetrahedrons impart a net negative charge to the pores that is responsible for holding the cations inside the pores and permits these cations to be readily exchanged with other cations.

Natural zeolites are aluminosilicates that can be represented by the general formula:

M_{a/n}O[(Al₂O₃)_{b}(SiO₂)_{c}].xH₂O

where M is a metal ion such as Na⁺, K⁺, Ca⁺², or Mg⁺²; n is the valence of the metal ion M; a, b, c, and x are positive integers, where the ratio a:n=2 and the ratio c:b is between 1:1 and 5:1. An example is the natural zeolite, natrolite, which has the structure:

Na₂O[(Al₂O₃)(SiO₂)₃].2H₂O.

The aluminosilicate framework is negatively charged and attracts the positive cations that reside within the structure's pores. When exposed to higher charged ions of a new element, zeolites will exchange ions of a lower charged element contained within the zeolite for ions of the higher charged element.

Examples of natural zeolites include: clinoptilolite (hydrated sodium, potassium, calcium aluminosilicate); analcime or analcite (hydrated sodium aluminum silicate); chabazite (hydrated calcium aluminum silicate); harmotome (hydrated barium potassium aluminum silicate); heulandite (hydrated sodium calcium aluminum silicate); laumontite (hydrated calcium aluminum silicate); mesolite (hydrated sodium calcium aluminum silicate); natrolite (hydrated sodium aluminum silicate); phill ipsite (hydrated potassium sodium calcium aluminum silicate); scolecite (hydrated calcium aluminum silicate); stellerite (hydrated calcium aluminum silicate); stilbite (hydrated sodium calcium aluminum silicate); and thomsonite (hydrated sodium calcium aluminum silicate).

Synthetic zeolites can be made by slow crystallization of silica-alumina gels in the presence of alkalis and organic templates. The exact composition and structure of the product formed depend on the composition of the reaction mixture, the pH of the medium, the operating temperature, the reaction time, and the template used. Zeolite A, for example, can be made by mixing a source of alumina, such as sodium aluminate, and a source of silica, such as sodium silicate, in basic aqueous solution to give a gel. The gel is then heated to 70-300° C. to crystallize the zeolite. Zeolite A has a 3-dimensional pore structure with pores running perpendicular to each other in the x, y, and z planes. The pore diameter is defined by an eight member oxygen ring and is relatively small at 4.2 Å. Zeolite A has a void volume fraction of 0.47, with a Si/Al ratio of 1.0. Other types of synthetic zeolites, such as zeolite Y, may also be used.

Commercially available zeolites include several products of Nippon Chemical, sold as the “Zeostar’ zeolites, including: Zeostar CA-100P and Zeostar CA-110P; Zeostar CX-100P and Zeostar CX-110P; Zeostar KA-100P and Zeostar KA-110P; Zeostar NA-100P and NA-110P; and Zeostar NX-100P and Zeostar NX-110P; and the VALFOR® zeolites and ADVERA® zeolites, such as VALFOR® 100 sodium aluminosilicate hydrated type Na-A zeolite powder and ADVERA® 401/401P hydrated sodium zeolite A (PQ Corp., Valley Forge, Pa.). Other sources of zeolites useful in the present invention include Zeochem LLC, UOP LLC and Anten Chemical Co. Ltd.

Zeolites useful in the invention include natural zeolites, synthetic zeolites, and mixtures thereof. The zeolite can be untreated or surface treated with such materials as higher fatty acids and their salts such as stearic acid, oleic acid, and salts of stearic acid and oleic acid, or salts of higher alkyl-, aryl-, or alkylaryl-sulfonic acids such as salts of dodecylbenzenesulfonic acid or the like. The zeolite may be calcined or uncalcined. Calcining may be carried out at 200° C. to 700° C. for a period of 1-10 hours, typically at 300° C. to 500° C. for a period of 2-5 hours.

The zeolite may also be an ion-exchanged zeolite, that is, a zeolite composition in which the alkali metal ions and/or alkaline earth ions of the aluminosilicate structure have been at least partially replaced by another metal ion. Typical metal ions that may be used include cations of Al, V, Mo, Mn, Fe, Co, Ni, Cu, Sn, Zn, Cr, Ti, Zr, W, Sb, Bi, B, and mixtures thereof, with zinc-exchanged zeolites being utilized in one desirable embodiment of the invention.

Ion-exchanged zeolites may be produced by stirring a mixture of the zeolite in an aqueous solution containing a water-soluble salt of the desired metal. In certain instances, it is preferable to stir the zeolite in a concentrated solution of sodium chloride in order to exchange sodium for the difficulty released potassium, calcium, and magnesium ions and then to effect further exchange of the sodium ions in a solution of the desired metal ion. The exchange may be carried out at about 20° C. to about 100° C., typically at about 40° C. to about 80° C.

The compositions of the present invention may contain at least 1, 2, or 3 weight %) zeolite or even higher levels (e.g., 12 to 15 weight % or more) if so desired.

One or more non-halogenated flame retardants such as a phosphorus-containing or melamine flame retardant may be present in the compositions of the present invention, in addition to the aforementioned zeolites. Phosphate esters are especially suitable for use. Such compounds include, for example, alkyl and aryl esters of phosphoric acid such as trimethyl phosphate, triethyl phosphate, tributyl phosphate, trioctyl phosphate, tributoxyethyl phosphate, triphenyl phosphate, tricresyl phosphate, cresyldiphenyl phosphate, octyldiphenyl phosphate, tri(2-ethylhexyl) phosphate, di-iso-propylphenyl phosphate, trixylenyl phosphate, tris(iso-propylphenyl) phosphate, trinaphthyl phosphate, bisphenol A diphenyl phosphate, and resorcinol diphenyl phosphate. Commonly used triaryl phosphates include, for example, triphenyl phosphate (TPP), cresyl diphenyl phosphate, and tricresyl phosphate. Inorganic phosphate flame retardants such as ammonium polyphosphate (which acts as an intumescent flame retardant) may also be utilized. In one aspect of the invention, the amount of phosphorus-containing flame retardant in the composition is not greater than 12 phr and can be, for example, no greater than 11, 10, 9, 8, 7, or 6 phr or even less if so desired.

Melamine flame retardants, including derivatives of melamine, may also be employed as non-halogenated flame retardants in the present invention. Any of the melamine flame retardants known in the art may be used, such as melamine cyanurate and melamine phosphates.

An anti-drip agent can also be present in the composition. Anti-drip agents include fluoropolymers, such as polytetrafluoroethylene (PTFE), which may be encapsulated by a rigid copolymer, such as styrene-acrylonitrile copolymer. PTFE encapsulated in a styrene-acrylic co-polymer is known as TSAN. The anti-drip agent will typically be in the form of a fine powder when formulated with the other components of the composition and comprise less than about 5 wt %, preferably about 1 wt % or less, for example about 0.1 wt % to about 1 wt % or about 0.1 wt % to about 0.5 wt %, of the composition, relative to the total weight of the composition.

A particularly preferred embodiment of the invention provides a composition comprising about 80 to about 90 weight % of a blend of polycarbonate and acrylonitrile butadiene styrene resin, wherein the blend has a polycarbonate: acrylonitrile butadiene styrene resin weight ratio of from about 3:1 to about 5:1, about 2 to about 6 weight % of at least one zeolite selected from the group consisting of natural zeolites and zinc-exchanged zeolites, about 8 to about 12 weight % triphenyl phosphate, and about 0.1 to about 0.5 weight % of fluoropolymer anti-drip agent, wherein the composition is essentially free of flame-retardant compounds that contain chlorine or bromine and essentially free of polymers that contain chlorine or bromine. The total amount of zeolite and triphenyl phosphate preferably is from about 13 weight % to about 15 weight %.

Another particularly preferred embodiment of the invention provides a composition comprising about 80 to about 90 weight % of a blend of polycarbonate and acrylonitrile butadiene styrene resin, wherein the blend has a polycarbonate: acrylonitrile butadiene styrene resin weight ratio of from about 7:1 to about 9:1, about 3 to about 6 weight % of at least one zeolite selected from the group consisting of natural zeolites and zinc-exchanged zeolites, about 10 to about 13 weight % bisphenol A bis(diphenyl)phosphate, and about 0.1 to about 0.5 weight % of fluoropolymer anti-drip agent, wherein the composition is essentially free of flame-retardant compounds that contain chlorine or bromine and essentially free of polymers that contain chlorine or bromine. The total amount of zeolite and bisphenol A bis(diphenyl)phosphate preferably is from about 15 weight % to about 17 weight %.

Both of these embodiments are capable of furnishing compositions having a UL-94 rating of V-0 when tested in ⅛″ thicknesses.

In another preferred embodiment of the invention, a composition is provided which comprises about 75 to about 75 weight % of polypropylene, about 5 to about 15 weight % of polyamide, about 2 to about 8 weight % of compatibilizer (in particular, a maleated polypropylene compatibilizer), about 5 to about 15 weight % of melamine flame retardant, about 3 to about 10 weight % zeolite, and 0 to about 0.5 weight % of fluoropolymer anti-drip agent, wherein the composition is essentially free of flame-retardant compounds that contain chlorine or bromine and essentially free of polymers that contain chlorine or bromine.

In another preferred embodiment of the invention, a composition is provided which comprises about 30 to about 45 weight % of polypropylene, about 10 to about 20 weight % of polyamide, about 2 to about 8 weight % of compatibilizer (in particular, a maleated polypropylene compatibilizer), about 30 to about 45 weight % of phosphorus-containing flame retardant (in particular, an ammonium polyphosphate-containing flame retardant), and about 3 to about 10 weight % zeolite, wherein the composition is essentially free of flame-retardant compounds that contain chlorine or bromine and essentially free of polymers that contain chlorine or bromine.

Both of these embodiments (containing a polypropylene/polyamide blend) are capable of furnishing compositions having a UL-94 rating of V-0 when tested in 1/16″ thicknesses. Ordinarily, good flame retardancy in polypropylene/polyamide blends is achievable only through the use of a relatively high proportion of the polyamide and/or a relatively high amount of a non-halogenated flame retardant such as ammonium polyphosphate. However, we have unexpectedly found that the addition of a zeolite to such a formulation permits the amount of ammonium polyphosphate to be advantageously reduced while maintaining good flame retardancy. Acceptable flame retardant properties thus can be attained even where the amount of polyamide is only 10 to 20 weight %, as the zeolite appears to complement the performance of the non-halogenated flame retardant.

The compositions of the present invention may be prepared by any of the methods known in the polymer art, including blending the organic polymer, zeolite, and any other components (e.g., non-halogenated flame retardant, anti-drip agent, filler, stabilizer, colorant, or other additives) with a conventional mixer. Melt compounding or melt extrusion using an internal kneader or one- or two-screw extruder can be utilized. The composition may be obtained in pellet form by extruding the blend with a conventional extruder.

Flame retardant polymer compositions of the present invention are suitable for use in many applications, including the electronics industry, the aeronautics and aerospace industries, the automotive industry, and the residential and commercial construction industries. For example, the compositions may be used to manufacture products such as aircraft and aerospace insulation, aircraft parts, fire-retardant automobile parts, personal computer housings, housing and building materials, home interior products, clothing and other household and industrial products.

The compositions of the present invention can be used for the preparation of shaped articles of all types. In particular, shaped articles can be produced by injection molding or other known molding techniques. Composites as well as foams may be manufactured using the compositions.

The advantageous properties of this invention can be observed by reference to the following examples, which illustrate but do not limit the invention.

### EXAMPLES

GLOSSARY

| | |
|---|---|
| Polycarbon- | DOWCALIBRE 303-10 injection and molding polycar- |
| ate resin | bonate resin (Dow Chemical Company, Midland, MI USA) |
| ABS | STAREX SD 0160W ABS resin (Samsung Chemical |
| | (USA), Inc., La Mirada, CA USA) |
| TEFLON ® | General purpose fluoropolymer resin (E. I. du Pont |
| 6C | de Nemours, Wilmington, DE USA) |
| TPP | Triphenyl phosphate |
| Zn Zeo/1 | Zinc-exchanged natural zeolite, exchanged once |
| pass | |
| Zn Zeo/2 | Zinc-exchanged natural zeolite, exchanged twice |
| pass | |

BAPP Bisphenol A bis(diphenyl)phosphate

### Zinc-Exchanged Zeolite

Zinc-exchanged zeolite is prepared by stirring the unexchanged zeolite in aqueous zinc chloride. The process uses about 15-20 ml of water per gram of unexchanged zeolite and 1 part by weight of zinc chloride per 2.6 parts by weight of unexchanged zeolite. The unexchanged zeolite is stirred in the aqueous zinc chloride for 20 hr. Then the resulting exchanged zeolite is filtered under vacuum, dried and pulverized. The amount of exchange can be increased by following the first exchange by a second exchange in which the exchanged zeolite from the first exchange is stirred for 2-8 hr in a more concentrated zinc chloride solution (50% higher concentration)) and then filtered and dried.

### Sample Evaluation

Samples were evaluated by the procedure of UL94, The Standard for Flammability of Plastic Materials for Parts in Devices and Appliances. UL94 determines a material's tendency either to extinguish or to spread the flame once the specimen has been ignited. The three vertical ratings, V2, V1 and V0 indicate that the material was tested in a vertical position and self-extinguished within a specified time after the ignition source was removed. The vertical ratings also indicate whether the test specimen dripped flaming particles that ignited a cotton indicator located below the sample. Test bars of the sample 125 mm (5 in) long and 13 mm (0.5 in) are mounted in the vertical position and exposed to flame. The test bars are either 1.5 mm ( 1/16 in) or 3.0 mm (⅛ in) thick. If the sample drips, the drips are allowed to fall onto a layer of dry absorbent surgical cotton placed 300 mm (about 12 in) below the sample. Ten test bars are tested per thickness. The ratings are as follows:

V-0—Burning stops within 10 seconds after two applications of ten seconds each of a flame to the test bar. No flaming drips are allowed.

V-1—Vertical Burn Burning stops within 60 seconds after two applications of ten seconds each of the flame to a test bar. No flaming drips are allowed.

V-2—Vertical Burn Burning stops within 60 seconds after two applications of ten seconds each of the flame to a test bar. Flaming drips are allowed.

Limiting oxygen index (LOI) was determined by ASTM D2863. Limiting oxygen index is the minimum concentration of oxygen that will just support flaming combustion in a flowing mixture of oxygen and nitrogen. A specimen is positioned vertically in a transparent test column and a mixture of oxygen and nitrogen is forced upward through the column. The specimen is ignited at the top. The oxygen concentration is adjusted until the specimen just supports combustion. The concentration reported is the volume percent of oxygen at which the specimen just supports combustion.

### Example 1

These examples show the use of zeolites in 8:1 polycarbonate/ABS. The samples shown in Table 1 were prepared and evaluated by UL94. The amount of each listed component is in weight %. Samples having thicknesses of 1.5 mm ( 1/16″) and 3.0 mm (⅛″) were evaluated.

TABLE 1
(8:1 PC/ABS).

| | Example No. | | | | | |
|---|---|---|---|---|---|---|
| Ingredient | 1-1 | 1-2 | 1-3 | 1-4 | 1-5 | 1-6 |
| Polycarbonate | 80.89 | 79.11 | 80.62 | 78.84 | 78.22 | 77.96 |
| ABS | 10.11 | 9.89 | 10.08 | 9.78 | 9.78 | 9.74 |
| TPP | 9 | 11 | 9 | 11 | 9 | 9 |
| TEFLON ® 6C | — | — | 0.3 | 0.3 | — | 0.3 |
| Synthetic Zeolite | — | — | — | — | 3 | 3 |
| (Na Exchanged) | | | | | | |
| Total | 100 | 100 | 100 | 100 | 100 | 100 |
| Phosphate:Zeolite, | — | — | — | — | 3 | 3 |
| wt/wt | | | | | | |
| Phosphate + | 9.9 | 12.4 | 9.9 | 12.4 | 13.6 | 13.7 |
| Zeolite, phr | | | | | | |
| LOI | 26 | 26 | 30 | 30 | 28 | 28 |
| UL-94 (⅛″) | V-2 | V-2 | V-0 | V-0 | V-2 | V-2 |
| UL-94 ( 1/16″) | V-2 | V-2 | V-1 | V-0 | V-2 | V-2 |

| | Example No. | | | | | |
|---|---|---|---|---|---|---|
| Ingredient | 1-7 | 1-8 | 1-9 | 1-10 | 1-11 | 1-12 |
| Polycarbonate | 78.22 | 77.96 | 77.96 | 78.22 | 77.96 | 76.44 |
| ABS | 9.78 | 9.74 | 9.74 | 9.78 | 9.74 | 9.56 |
| TPP | 9 | 9 | 9 | 9 | 11 | 11 |
| TEFLON ® 6C | — | 0.3 | 0.3 | — | 0.3 | — |
| Synthetic Zeolite | — | — | — | — | 3 | 3 |
| (Na Exchanged) | | | | | | |
| Natural Zeolite | 3 | 3 | — | — | — | — |
| Zn Zeo/2 pass | — | — | 3 | 3 | — | — |
| Total | 100 | 100 | 100 | 100 | 100 | 100 |
| Phosphate:Zeolite, | 3 | 3 | 3 | 3 | 3.7 | 3.7 |
| wt/wt | | | | | | |
| Phosphate + | 13.6 | 13.7 | 13.7 | 13.6 | 13.7 | 16.3 |
| Zeolite, phr | | | | | | |
| LOI | 27 | 32 | — | 27 | 29 | 28 |
| UL-94 (⅛″) | Fail | V-0 | V-0 | V-2 | V-0 | V-2 |
| UL-94 ( 1/16″) | V-2 | V-1 | V-1 | V-2 | V-0 | V-2 |
| | Example No. | | | | | |
| Ingredient | 1-13 | 1-14 | 1-15 | 1-16 | 1-17 | 1-18 |
| Polycarbonate | 76.18 | 76.44 | 76.18 | 76.44 | 76.18 | 80.00 |
| ABS | 9.52 | 9.56 | 9.52 | 9.56 | 9.52 | 10.00 |
| TPP | 11 | 11 | 11 | 11 | 11 | 7 |
| TEFLON ® 6C | 0.3 | — | 0.3 | — | 0.3 | — |
| Synthetic Zeolite | 3 | — | — | — | — | 3 |
| (Na Exchanged) | | | | | | |
| Natural Zeolite | — | 3 | 3 | — | — | — |
| Zn Zeo/2 pass | — | — | — | 3 | 3 | — |
| Total | 100 | 100 | 100 | 100 | 100 | 100 |
| Phosphate:Zeolite, | 3.7 | 3.7 | 3.7 | 3.7 | 3.7 | 2.3 |
| wt/wt | | | | | | |
| Phosphate + | 16.3 | 16.3 | 16.3 | 16.3 | 16.3 | 11.1 |
| Zeolite, phr | | | | | | |
| LOI | 28 | 28 | 30 | 28 | 33 | 28 |
| UL-94 (⅛″) | V-2 | V-2 | V-0 | Fail | V-0 | V-2 |
| UL-94 ( 1/16″) | V-2 | V-2 | V-0 | Fail | V-1 | V-2 |

| | Example No. | | | | |
|---|---|---|---|---|---|
| Ingredient | 1-19 | 1-20 | 1-21 | 1-22 | 1-23 |
| Polycarbonate | 79.73 | 80.00 | 79.73 | 80.00 | 79.73 |
| ABS | 9.97 | 10.00 | 9.97 | 10.00 | 9.97 |
| TPP | 7 | 7 | 7 | 7 | 7 |
| TEFLON ® 6C | 0.3 | — | 0.3 | — | 0.3 |
| Synthetic Zeolite | 3 | — | — | — | — |
| (Na Exchanged) | | | | | |
| Natural Zeolite | — | 3 | 3 | — | — |
| Zn Zeo/2 pass | — | — | — | 3 | 3 |
| Total | — | 100 | 100 | 100 | 100 |
| Phosphate:Zeolite, | 2.3 | 2.3 | 2.3 | 2.3 | 2.3 |
| wt/wt | | | | | |
| Phosphate + | 11.1 | 11.1 | 11.1 | 11.1 | 11.1 |
| Zeolite, phr | | | | | |
| LOI | 28 | 26 | 32 | 27 | 29 |
| UL-94 (⅛″) | V-2 | V-2 | V-0 | V-2 | V-0 |
| UL-94 ( 1/16″) | V-2 | Fail | V-2 | Fail | V-1 |

| | Example No. | | | | | |
|---|---|---|---|---|---|---|
| Ingredient | 1-24 | 1-25 | 1-26 | 1-27 | 1-28 | 1-29 |
| Polycarbonate | 77.96 | 78.22 | 76.18 | 75.56 | 80.00 | 79.73 |
| ABS | 9.74 | 9.78 | 9.52 | 9.44 | 10.00 | 9.97 |
| TPP | 9 | 9 | 11 | 12 | 7 | 7 |
| TEFLON ® 6C | 0.3 | — | 0.3 | — | — | 0.3 |
| Natural Zeolite | — | — | — | — | — | — |
| Zn Zeo/1 pass | 3 | 3 | 3 | 3 | 3 | 3 |
| Total | 100 | 100 | 100 | 100 | 100 | 100 |
| Phosphate:Zeolite, | 3 | 3 | 3.7 | 4 | 2.3 | 2.3 |
| wt/wt | | | | | | |
| Phosphate + | 13.7 | 13.6 | 16.3 | 17.6 | 11.1 | 11.1 |
| Zeolite, phr | | | | | | |
| LOI | | | | | | |
| UL-94 (⅛″) | V-0 | V-2 | V-0 | V-2 | V-2 | V-1 |
| UL-94 ( 1/16″) | V-1 | V-2 | V-1 | V-2 | V-2 | Fail |
| | Example No. | | | | | |
| Ingredient | 1-30 | 1-31 | 1-32 | 1-33 | 1-34 | 1-35 |
| Polycarbonate | 79.73 | 79.73 | 79.73 | 79.73 | 76.18 | 76.18 |
| ABS | 9.97 | 9.97 | 9.97 | 9.97 | 9.52 | 9.52 |
| TPP | 5 | 5 | 5 | 5 | 9 | 9 |
| TEFLON ® 6C | 0.3 | 0.3 | 0.3 | 0.3 | 0.3 | 0.3 |
| Synthetic Zeolite | — | — | 5 | — | 5 | — |
| (Na Exchanged) | | | | | | |
| Natural Zeolite | — | 5 | — | — | — | 5 |
| Zn Zeo/1 pass | 5 | — | — | — | — | — |
| Zn Zeo/2 pass | — | — | — | 5 | — | — |
| Total | 100 | 100 | 100 | 100 | 100 | 100 |
| Phosphate:Zeolite, | 1 | 1 | 1 | 1 | 1.8 | 1.8 |
| wt/wt | | | | | | |
| Phosphate + | 11.1 | 11.1 | 11.1 | 11.1 | 16.3 | 16.3 |
| Zeolite, phr | | | | | | |
| LOI | | | | | | |
| UL-94 (⅛″) | V-2 | V-0 | V-2 | V-0 | | |
| UL-94 ( 1/16″) | V-2 | Fail | V-2 | V-1 | | |

### Example 2

These examples illustrate use of zeolites in 4:1 polycarbonate/ABS (wt/wt). The procedures of Example 1 were repeated using the compositions shown in Table 2. The results are shown in Table 2. Remarkably, a rating of V-0 at thicknesses of both ⅛″ and 1/16″ is achieved using both second pass Zn-exchanged zeolite and natural zeolite with very high LOI values. These types of zeolites thus are preferred to sodium-exchanged zeolites for this particular application.

TABLE 2
(4:1 PC/ABS).

| | Example No. | | | | | |
|---|---|---|---|---|---|---|
| Ingredient | 2-1 | 2-2 | 2-3 | 2-4 | 2-5 | 2-6 |
| Polycarbonate | 71.20 | 68.80 | 70.96 | 68.56 | 68.80 | 68.56 |
| ABS | 17.80 | 17.20 | 17.74 | 17.14 | 17.20 | 17.14 |
| TPP | 11 | 14 | 11 | 14 | 11 | 11 |
| TEFLON ® 6C | — | — | 0.3 | 0.3 | — | 0.3 |
| Synthetic Zeolite | — | — | — | — | 3 | 3 |
| (Na Exchanged) | | | | | | |
| Total | 100 | 100 | 100 | 100 | 100 | 100 |
| Phosphate:Zeolite, | — | — | — | — | 3.7 | 3.7 |
| wt/wt | | | | | | |
| Phosphate + | 12.4 | 16.3 | 12.4 | 16.3 | 16.3 | 16.3 |
| Zeolite, phr | | | | | | |
| LOI | 24 | 26 | 27 | 27 | 26 | 28 |
| UL-94 (⅛″) | V-2 | V-2 | V-0 | V-0 | V-2 | V-2 |
| UL-94 ( 1/16″) | V-2 | V-2 | V-2 | V-2 | V-2 | V-2 |

| Ingredient | 2-7 | 2-8 | 2-9 | 2-10 |
|---|---|---|---|---|
| Polycarbonate | 68.56 | 68.56 | 68.56 | 68.56 |
| ABS | 17.14 | 17.14 | 17.14 | 17.14 |
| TPP | 11 | 11 | 9 | 9 |
| TEFLON ® 6C | 0.3 | 0.3 | 0.3 | 0.3 |
| Synthetic Zeolite | — | — | — | — |
| (Na Exchanged) | | | | |
| Natural Zeolite | 3 | — | — | 5 |
| Zn Zeo/2 pass | — | 3 | 5 | — |
| Total | 100 | 100 | 100 | 100 |
| Phosphate:Zeolite, | 3.7 | 3.7 | 1.8 | 1.8 |
| wt/wt | | | | |
| Phosphate + | 16.3 | 16.3 | 16.3 | 16.3 |
| Zeolite, phr | | | | |
| LOI | 26 | 30 | 28 | 32 |
| UL-94 (⅛″) | V-0 | V-0 | V-0 | V-0 |
| UL-94 ( 1/16″) | V-1 | V-0 | V-0 | V-0 |

### Example 3

These examples illustrate the use of zeolites in 8:1 polycarbonate/ABS (wt/wt) as well as polycarbonate alone. The procedures of Example 1 were repeated using the compositions shown in Table 3. The results are shown in Table 3. Example 3-1 is a control example containing no zeolite, but a relatively high amount of a phosphorus-containing flame retardant (16.3 phr of BAPP). Substituting zeolite for a portion of the phosphorus-containing flame retardant improved the heat distortion temperature dramatically (compare Examples 3-2 and 3-3 with Example 3-1). At the same time, however, good flame retardant properties were retained, particularly when ⅛″ thick samples were evaluated.

TABLE 3

| Ingredient | 3-1 | 3-2 | 3-3 | 3-4 | 3-5 | 3-6 | 3-7 |
|---|---|---|---|---|---|---|---|
| Polycarbonate | 76.18 | 76.18 | 76.18 | 74.40 | 74.40 | 89.50 | 94.60 |
| ABS | 9.52 | 9.52 | 9.52 | 9.30 | 9.30 | — | — |
| BAPP | 14 | 10 | 10 | 10 | 10 | — | — |
| TEFLON ® 6C | 0.3 | 0.3 | 0.3 | 0.3 | 0.3 | 0.5 | 0.4 |
| Synthetic Zeolite (Na | — | — | — | — | — | 10 | — |
| Exchanged) | | | | | | | |
| Natural Zeolite | — | 4 | — | 6 | — | — | — |
| Zn Zeo/2-pass | — | — | 4 | — | 6 | — | 5 |
| Total | 100.00 | 100.00 | 100.00 | 100.00 | 100.00 | 100.00 | 100.00 |
| Phosphate: Zeolite | — | 2.5 | 2.5 | 1.7 | 1.7 | 0 | 0 |
| Phosphate + Zeolite, | 16.3 | 16.3 | 16.3 | 19.1 | 19.1 | 11.2 | 5.3 |
| phr | | | | | | | |
| Oxygen Index | | | | | | | |
| UL-94 (⅛″) | V-0 | V-0 | V-0 | V-0 | V-0 | V-1 | V-2 |
| UL-94 ( 1/16″) | V-0 | V-1 | V-1 | V-1 | V-2 | V-1 | V-2 |
| Notched Izod, ft-lb/in | 1.07 | 0.99 | 0.89 | 0.77 | 0.92 | 1.04 | 1.17 |
| Tensile @ Yield, psi | 9918 | 9526 | 9740 | 9462 | 9705 | 9041 | 9477 |
| Tensile @ Break, psi | 7094 | 7175 | 6995 | 7052 | 6823 | 7284 | 6882 |
| % Elongation @ Break | 64 | 44 | 29 | 34 | 26 | 19 | 28 |
| Flex Modulus, psi | 426043 | 397803 | 408658 | 413091 | 402149 | 389047 | 390949 |
| HDT ° C., Average | 76.7 | 85.6 | 85 | 86 | 86 | 115.5 | 109.0 |
| HDT ° F., Average | 170 | 186.1 | 184.9 | 186.8 | 186.8 | 239.8 | 228.3 |

| Ingredient | 3-8 | 3-9 | 3-10 | 3-11 |
|---|---|---|---|---|
| Polycarbonate | 74.4 | 74.4 | 74.4 | 74.4 |
| ABS | 9.3 | 9.3 | 9.3 | 9.3 |
| BAPP | 12 | 12 | 11 | 11 |
| TEFLON ® 6C | 0.3 | 0.3 | 0.3 | 0.3 |
| ADVERA ® | — | — | — | — |
| Ultra Zeo | — | 4 | — | 5 |
| Zn Zeo/2-pass | 4 | — | 5 | — |
| Total | 100.00 | 100.00 | 100.00 | 100.00 |
| Phosphate:Zeolite | 3 | 3 | 2.2 | 2.2 |
| Phosphate + Zeolite, | 19.1 | 19.1 | 19.1 | 19.1 |
| phr | | | | |
| Oxygen Index | | | | |
| UL-94 (⅛″) | V-0 | V-0 | V-0 | V-0 |
| UL-94 ( 1/16″) | V-0 | V-0 | V-0 | V-0 |

### Example 4

These examples demonstrate the use of different synthetic zeolites (Zeolites A-G) to improve flame retardancy in 8:1 polycarbonate/ABS (wt/wt). Each example was prepared using 77.96 weight % DOWCALIBRE 303-10 polycarbonate, 9.74 weight % STAREX SD 160W ABS, 9.00 weight % triphenyl phosphate, 0.3 weight % TEFLON 6C fluoropolymer resin, and 3.00 weight % zeolite. The procedures described in Example 1 were employed to evaluate each sample by the UL94 test method. The results observed are reported in Table 4. Examples 4-1, 4-5 and 4-6 exhibited the best flame retardant properties and demonstrate that a UL-94 rating of V-0 can be achieved at both ⅛″ and 1/16″ sample thicknesses using certain synthetic zeolites (Zeolites A, E and F) in combination with only 9 weight % triphenyl phosphate and a fluoropolymer resin anti-drip agent.

TABLE 4
(8:1 PC/ABS).

| Example | 4-1 | 4-2 | 4-3 | 4-4 | 4-5 | 4-6 | 4-7 |
|---|---|---|---|---|---|---|---|
| Zeolite | A | B | C | D | E | F | G |
| UL-94 | V-0 | V-1 | V-0 | V-2 | V-0 | V-0 | V-1 |
| (⅛″) | | | | | | | |
| UL-94 | V-0 | V-2 | V-2 | V-2 | V-0 | V-0 | V-2 |
| ( 1/16″) | | | | | | | |

### Example 5

These examples further demonstrate the effect of different synthetic zeolites on the flammability characteristics of 8:1 polycarbonate/ABS (wt/wt). Each example was prepared using 76.44 weight % DOWCALIBRE 303-10 polycarbonate, 9.56 weight % STAREX SD 160W ABS, 11.00 weight % triphenyl phosphate, and 3.00 weight % synthetic zeolite (Zeolites A-G). The procedures described in Example 1 were employed to evaluate each sample by the UL-94 test method. The results observed are reported in Table 5. In each example, a UL-94 rating of V-2 was obtained, regardless of the thickness of the sample. When compared to the results obtained in Example 4, these results demonstrate the benefits of including a fluoropolymer resin in the formulation as an anti-drip agent. That is, even when 3 weight % zeolite is used in combination with a relatively high level of phosphorus-containing flame retardant (11 weight %), a UL-94 rating of V-0 could not be achieved in the absence of the anti-drip agent.

TABLE 5
(8:1 PC/ABS).

| Example | 5-1 | 5-2 | 5-3 | 5-4 | 5-5 | 5-6 | 5-7 |
|---|---|---|---|---|---|---|---|
| Zeolite | A | B | C | D | E | F | G |
| UL-94 | V-2 | V-2 | V-2 | V-2 | V-2 | V-2 | V-2 |
| (⅛″) | | | | | | | |
| UL-94 | V-2 | V-2 | V-2 | V-2 | V-2 | V-2 | V-2 |
| ( 1/16″) | | | | | | | |

### Example 6

These examples further demonstrate the effect of different synthetic zeolites on the flammability characteristics of 8:1 polycarbonate/ABS (wt/wt) containing somewhat lower levels of triphenyl phosphate than were used in Example 4. Each example was prepared using 79.73 weight % DOWCALIBRE 303-10 polycarbonate, 9.97 weight % STAREX SD 160W ABS, 7.00 weight % triphenyl phosphate, 0.3 weight % TEFLON 6C fluoropolymer resin and 3.00 weight % synthetic zeolite (Zeolites A-G). The procedures described in Example 1 were employed to evaluate each sample by the UL94 test method. The results observed are reported in Table 6 and show that a UL-94 rating of V-0 in a ⅛″ thick sample can be achieved using 3 weight % Zeolite E or F in combination with a fluoropolymer resin anti-drip agent and a relatively low amount of phosphorus-containing flame retardant (7 weight %).

TABLE 6
(8:1 PC/ABS).

| Example | 6-1 | 6-2 | 6-3 | 6-4 | 6-5 | 6-6 | 6-7 |
|---|---|---|---|---|---|---|---|
| Zeolite | A | B | C | D | E | F | G |
| UL-94 | V-1 | V-2 | V-1 | V-2 | V-0 | V-0 | V-2 |
| (⅛″) | | | | | | | |
| UL-94 | V-0 | V-2 | V-2 | V-2 | V-1 | V-1 | V-2 |
| ( 1/16″) | | | | | | | |

### Example 7

These examples demonstrate attempts to achieve flame retardancy in formulations based on blends of a polypropylene (Brasken TI4020N impact copolymer having a melt flow of 2 g/10 min under 130° C. 2.16 Kg weight in accordance with the ASTM D1238 method) and either an epoxy novolac resin (D.E.N. 439, available from Dow Chemical) or a polyimide (nylon 6) also containing a compatibilizer (EXXELOR PP-MA-1020, a maleated polypropylene available from ExxonMobil Chemical). The flame retardant employed was resorcinol diphosphate. As may be seen in Table 7, all formulations had a UL-94 rating of V-2 in a 1/16″ sample, with the Oxygen Index ranging from 19 to 22. All samples dripped; Examples 7-3 and 7-7 came to closest to achieving a UL-94 rating of V-0.

TABLE 7

| Ingredient | 7-1 | 7-2 | 7-3 | 7-4 | 7-5 | 7-6 | 7-7 |
|---|---|---|---|---|---|---|---|
| Polypropylene | 75 | 75 | 74.7 | 70 | 70 | 65 | 64.7 |
| Compatibilizer | 5 | 5 | 5 | 5 | 5 | 5 | 5 |
| Epoxy Novolac | 10 | 0 | 0 | 0 | 0 | 0 | 0 |
| Resin | | | | | | | |
| Resorcinol | 10 | 10 | 10 | 10 | 15 | 10 | 10 |
| Diphosphate | | | | | | | |
| Polyamide | 0 | 10 | 10 | 15 | 10 | 20 | 20 |
| TEFLON ® | 0 | 0 | 0.3 | 0 | 0 | 0 | 0.3 |
| UL-94 | V-2 | V-2 | V-2 | V-2 | V-2 | V-2 | V-2 |
| ( 1/16″) | | | | | | | |
| LOI | 19 | 21 | 20 | 19 | 22 | 20 | 20 |

### Example 8

These examples demonstrate the effect of including a Na-exchanged synthetic zeolite on the flame retardant properties of formulations based on the polypropylene used in Example 7 and a polyamide (nylon 6) also containing a compatibilizer (EXXELOR PP-MA-1020, a maleated polypropylene available from ExxonMobil Chemical). A melamine type flame retardant (MELAPUR M200 or MELAPUR MC-25, both available from Ciba) was also present. The results shown in Table 8 indicate that zeolite may be substituted for a portion of the melamine type flame retardant without significantly affecting the flame retardancy, as measured by the UL-94 rating and the Limiting Oxygen index.

TABLE 8

| Ingredient | 8-1 | 8-2 | 8-3 | 8-4 | 8-5 |
|---|---|---|---|---|---|
| Polypropylene | 75 | 69.7 | 74.7 | 75 | 69.7 |
| Compatibilizer | 5 | 5 | 5 | 5 | 5 |
| MELAPUR M200 | 0 | 0 | 0 | 10 | 15 |
| MELAPUR MC-25 | 10 | 15 | 10 | 0 | 0 |
| Zeolite | 0 | 0 | 0 | 0 | 0 |
| Polyamide | 10 | 10 | 10 | 10 | 10 |
| TEFLON ® | 0 | 0.3 | 0.3 | 0 | 0.3 |
| UL-94 ( 1/16″) | V-2 | V-2 | V-2 | V-2 | V-2 |
| LOI | 19 | 19 | 19 | 20 | 20 |
| Ingredient | 8-8 | 8-9 | 8-10 | 8-11 | 8-12 |
| Polypropylene | 70 | 69.7 | 65 | 60 | 59.7 |
| Compatibilizer | 5 | 5 | 5 | 5 | 5 |
| MELAPUR M200 | 0 | 0 | 0 | 0 | 0 |
| MELAPUR MC-25 | 10 | 10 | 20 | 25 | 25 |
| Zeolite | 5 | 5 | 0 | 0 | 0 |
| Polyamide | 10 | 10 | 10 | 10 | 10 |
| TEFLON ® | 0 | 0.3 | 0 | 0 | 0.3 |
| UL-94 ( 1/16″) | V-2 | V-2 | V-2 | V-2 | V-2 |
| LOI | 19 | 19 | 20 | 20 | 20 |

### Example 9

These examples demonstrate the effect of including a Na-exchanged synthetic zeolite on the flame retardant properties of formulations based on the polypropylene used in Example 7 and a polyamide (nylon 6) also containing a compatibilizer (EXXELOR PP-MA-1020, a maleated polypropylene available from ExxonMobil Chemical). An ammonium polyphosphate-based flame retardant (BUDIT 3167, available from Budenheim) was also present. The results shown in Table 9 indicate that zeolite may be substituted for a portion of the flame retardant without significantly affecting the flame retardancy, as measured by the UL-94 rating and the Limiting Oxygen Index. The first set of test results reported in Table 9 was obtained using samples prepared using a Brabender mixer. The second set of test results reported in Table 9 was obtained using samples prepared using a Banbury mixer.

TABLE 9

| Ingredient | 9-1 | 9-2 | 9-3 | 9-4 | 9-5 | 9-6 | 9-7 |
|---|---|---|---|---|---|---|---|
| Polypropylene | 30 | 35 | 35 | 37.5 | 40 | 39 | 40 |
| Compatibilizer | 10 | 10 | 5 | 5 | 5 | 4 | 5 |
| BUDIT 3167 | 40 | 35 | 40 | 37.5 | 35 | 34 | 35 |
| Zeolite | 0 | 0 | 5 | 5 | 5 | 9 | 20 |
| Polyamide | 20 | 20 | 15 | 15 | 15 | 14 | 0 |
| UL-94 ( 1/16″) | V-0 | V-2 | V-0 | V-0 | V-0 | V-0 | V-2 |
| LOI | 40 | 36 | 48 | 48 | 47 | 41 | 24 |
| Tensile | 3980 | 4369 | 4243 | 4523 | 3727 | 4188 | 3723 |
| Strength (psi) | | | | | | | |
| Tensile | 4.79 | 9.59 | 9.07 | 10 | 9.52 | 11 | 8.5 |
| Elongation (%) | | | | | | | |
| Young's | 153583 | 143725 | 159467 | 152092 | 141248 | 147179 | 150863 |
| Modulus (psi) | | | | | | | |
| Flex Strength @ | 64666 | 6997 | 7054 | 7453 | 6056 | 6894 | 5981 |
| Yield (psi) | | | | | | | |
| Flex Strain | 6.82 | 8.39 | 8.41 | 8.04 | 8.17 | 8.23 | 5.78 |
| @ Yield (psi) | | | | | | | |
| Flex | 287718 | 284364 | 303054 | 310821 | 273250 | 282807 | 279412 |
| Modulus (psi) | | | | | | | |
| UL-94 ( 1/16″) | V-0 | V-2 | V-0 | V-0 | V-0 | V-0 | V-2 |
| Melt Index, Cond. L | 10.67 | 8 | 1.3 | 1.42 | 2.3 | 1.15 | 1.12 |
| 230° C./2.16 kg | | | | | | | |
| LOI | 44 | 40 | 50 | 46 | 50 | 39 | 22 |

What is claimed is:

1. A composition comprising:
a) 100 parts by weight of organic polymer;
(b) optionally, a non-halogenated flame retardant; and
(c) at least 3 parts by weight of zeolite;
wherein the composition is essentially free of flame-retardant compounds that contain chlorine or bromine and essentially free of polymers that contain chlorine or bromine.

2. The composition of claim 1, wherein the organic polymer comprises polycarbonate.

3. The composition of claim 1, wherein the organic polymer comprises polycarbonate and acrylonitrile butadiene styrene resin.

4. The composition of claim 1, wherein the organic polymer comprises polypropylene.

5. The composition of claim 1, wherein the organic polymer comprises polypropylene and polyamide.

6. The composition of claim 1, comprising at least two different organic polymers and a compatibilizer.

7. The composition of claim 1, additionally comprising at least one fluoropolymer anti-drip agent.

8. The composition of claim 1, comprising ion-exchanged zeolite.

9. The composition of claim 1, comprising zinc-exchanged zeolite.

10. The composition of claim 1, comprising at least one non-halogenated flame retardant selected from the group consisting of phosphorus-containing flame retardants and melamine flame retardants.

11. A composition comprising about 80 to about 90 weight % of a blend of polycarbonate and acrylonitrile butadiene styrene resin, wherein the blend has a polycarbonate:acrylonitrile butadiene styrene resin weight ratio of from about 3:1 to about 5:1, about 2 to about 6 weight % of at least one zeolite selected from the group consisting of natural zeolites and zinc-exchanged zeolites, about 8 to about 12 weight % triphenyl phosphate, and about 0.1 to about 0.5 weight % of fluoropolymer anti-drip agent, wherein the composition is essentially free of flame-retardant compounds that contain chlorine or bromine and essentially free of polymers that contain chlorine or bromine.

12. A composition comprising about 80 to about 90 weight % of a blend of polycarbonate and acrylonitrile butadiene styrene resin, wherein the blend has a polycarbonate:acrylonitrile butadiene styrene resin weight ratio of from about 7:1 to about 9:1, about 3 to about 6 weight % of at least one zeolite selected from the group consisting of natural zeolites and zinc-exchanged zeolites, about 10 to about 13 weight % bisphenol A bis(diphenyl)phosphate, and about 0.1 to about 0.5 weight % of fluoropolymer anti-drip agent, wherein the composition is essentially free of flame-retardant compounds that contain chlorine or bromine and essentially free of polymers that contain chlorine or bromine.

13. A composition comprising about 75 to about 75 weight % of polypropylene, about 5 to about 15 weight % of polyamide, about 2 to about 8 weight % of compatibilizer, about 5 to about 15 weight % of melamine flame retardant, about 3 to about 10 weight % zeolite, and 0 to about 0.5 weight % of fluoropolymer anti-drip agent, wherein the composition is essentially free of flame-retardant compounds that contain chlorine or bromine and essentially free of polymers that contain chlorine or bromine.

14. A composition comprising about 30 to about 45 weight % of polypropylene, about 10 to about 20 weight % of polyamide, about 2 to about 8 weight % of compatibilizer, about 30 to about 45 weight % of phosphorus-containing flame retardant, and about 3 to about 10 weight % zeolite, wherein the composition is essentially free of flame-retardant compounds that contain chlorine or bromine and essentially free of polymers that contain chlorine or bromine.

15. A method of improving the flame retardancy of an organic polymer, said method comprising combining 100 parts by weight of said organic polymer with at least 3 parts by weight zeolite but essentially no flame-retardant compound that contains chlorine or bromine and essentially no polymer that contains chlorine or bromine.
